(19) United States
(12) Patent Application Publication
(10) Pub. No.: US 2018/0097974 A1
(43) Pub. Date: Apr. 5, 2018

(54) VIDEO-TREE SYSTEM FOR INTERACTIVE MEDIA REPRODUCTION, SIMULATION, AND PLAYBACK

(71) Applicant: App Onboard, Inc., Los Angeles, CA (US)

(72) Inventors: Jonathan Lee Zweig, Los Angeles, CA (US); Adam Piechowicz, Santa Monica, CA (US)

(21) Appl. No.: 15/614,425

(22) Filed: Jun. 5, 2017

Related U.S. Application Data
(60) Provisional application No. 62/403,638, filed on Oct. 3, 2016.
(60) Provisional application No. 62/415,674, filed on Nov. 1, 2016.

(51) Int. Cl. H04N 5/222; A63F 13/61; G06Q 30/02; G06F 3/0488

(52) U.S. Cl. CPC H04N 5/2224; G06F 3/04883; G06Q 30/0267; A63F 13/61

(57) ABSTRACT

The system and method for application re-creation centers on the need for the rapid recreation of applications and playable media for uses in testing, simulation, sampling, marketing, and feature optimization. Using a video-tree system, this disclosure allows for application reproduction, simulation and playback by first and third parties with a high degree of accuracy. The underlying method for reproduction centers on a branching approach to recording applications (i.e., digital video formats), and the stitching of the sampled digital video using a taxonomical branching of user journeys. The technology simplifies the process of providing accurate, high efficacy samples and reproductions of applications. The sample experiences are provided via a scripting and configuration file linked to a plurality of video branches. The video branches are stitched in a method to mimic the look and feel of the original application.

### CLAIM OF PRIORITY

This application claims the benefit of priority under 35 U.S.C. § 119(e) to U.S. provisional application Ser. Nos. 62/403,638, filed Oct. 3, 2016, and 62/415,674, filed Nov. 1, 2016, both of which are incorporated herein by reference in their entirety.

### TECHNICAL FIELD

Online gaming, mobile gaming, mobile application products, consumer mobile applications, playable advertising media, video and interactive web, and specifically application development and optimizing the replication of applications without requiring access to the native application source code.

### BACKGROUND

Instances of interactive media are found throughout users' daily interactions with computers. Ranging from the simple play-back of a video within a web page to elaborate online gaming applications, interactive media are controlled by application software of varying complexity, which must be able to process real-time inputs from a user. This software frequently needs to be deployed quickly for testing, sampling, or promotion. Today, software application developers must provide their source code in order for applications to be reproduced accurately. For instance, the developer of a mobile soccer game must generally provide the game's source code in order to reproduce the game on a consumer device such as a mobile phone or tablet, desktop computer, or laptop. Therefore, providing access to a sample of the application on a new platform, requires the lengthy and cumbersome process of delivering the code, which usually requires a digital transfer (such as downloading, saving, then uploading) of the code, and launching the application from the new machine. In scenarios in which an application developer wishes to make available only short segments of an application, the developer must define the exact program's parameters for the samples, and cut the program portion they wish to share as a sample. The sampling process can become exponentially more difficult as the complexity of the application increases, such that playing back even just a short 3-minute sample could require the delivery of large amounts of source code. Modern-day gaming applications, for instance, have a variety of possible gamer interactions, storylines, results, features, and interfaces. As such, the non-linearity of modern-day applications requires the delivery of significant portions of source code in order to accurately reproduce even a short sampling of the application by a user.

Existing methods for producing application samples are unable to reproduce the application experience with high efficacy. Existing application reproduction approaches fall into three categories: First, reproduction of the application by writing new source code designed to execute the application features and functionality; second, streaming a recorded video of the application; and third, streaming a remote-interactive session with a running instance of the program. Each approach falls short of producing a convincing sampling of the application experience.

In the first approach, reproduction by writing new source code, the replicating entity must manually write code based on nothing more than their knowledge of the application derived from using the application. Without having access to the original application source code, this requires a developer to use their best intuition to reproduce the original application code without having access to it. Given the complexity of digital gaming and the variety of software programming styles, the product of this approach rarely results in the look and feel of the original application even if the functionality is successfully replicated. Furthermore, given that the program itself is likely to change over time, it can be a struggle to adapt to new functionalities. Likewise, the time and expense associated with reproducing the look and feel of a digital game is cost prohibitive for most parties. Even by co-opting a third party to assist in order to reduce costs, there may still be issues with communication and a protracted production timeline. Additionally the replicating entity may be faced with distribution limitations: for example, online App Stores do not allow public “demo” publishing.

In the second approach, streaming a recorded video of the application, the replicating entity produces a screen recording of a user interacting with the application. The screen recording can be replayed and streamed over the web. In order to include live interactions with the screen recording, the entity can augment the video by editing it. Overlaying tutorials on digital video using a video editing software allows for viewers to engage with the video visually, but does not provide a user with a way to interactively engage with the application. Alternatively, the reproducing entity could overlay interactive programming over a streaming video, such that clicking on specific portions of the video would produce a defined video segment. While this method produces some interactivity with the digital video, the fluidity of the interaction is noticeably inadequate in simulating the look and feel of the original application.

In the third approach, streaming a remote-interactive session with the application, the replicating entity runs the product on a server and allows users to connect with it remotely using a technique similar to screen sharing. This approach involves high resource requirements for processing power on the server side and significant bandwidth on the user's side. In many situations, conditions will not be ideal and will result in low quality video or latency in responsiveness that does not accurately represent the quality of the product. It can be difficult to configure applications to ‘reset’ in this environment to reliably present the same experience repeatedly. Hardware or software problems can be difficult to detect: For example, connection to the application can be diverted so that a user, instead of seeing the expected application, is re-routed to a pop-up screen for a platform upgrade. As such, users are not reliably provided with an interactive application experience. Streaming based approaches more often than not result in issues of latency, loading, versioning control, and poor integration of sound and effects. It is well accepted by the industry that streaming video of applications produces an inferior user experience compared to running source code directly.

In sum, existing methods of application reproduction are slow, segmented, require long development processes, and lack efficacy in producing an accurate rendition of the experience of using the original application.

Application sampling is also used for testing new features of an application before making the application available in an application store such as “Google Play” or the “Apple iOS App Store.” Both the leading application stores require approval prior to making application feature updates available to app store customers. That is, in order for application developers to test new functionality of an application (by exposure to actual users), that new functionality first has to be approved. As such, the timeline for testing the functionality with users is unduly prolonged by the application store approval process. Many application developers do not feel that the process is sufficient to meet the market demands of producing new application content for users. There are few public-facing alternatives to testing new application features and content against a sample user group. Third parties have attempted to create feature testing platforms for application developers, but given the difficulty of application sampling and reproduction, many of these third parties fail to provide a robust and accurate experience to application testers. Given this, test users end up providing feedback after interacting with a lesser-quality version of the application, and end up creating a misaligned feedback loop to the developers.

### SUMMARY

The system and method for application replication described herein centers on the need for the rapid recreation of applications for uses in testing, simulation, sampling, marketing, and feature optimization. Using a video-tree system, the technology allows for reproduction (such as simulation and playback) by third parties of interactive media, such as an application program or inline video advertisement, with a high degree of accuracy, without the delivery of the original application's source code. The underlying method for reproduction centers on a branching approach to recording applications (such as digital video formats), and the stitching of the sampled digital video using a taxonomical branching of user journeys.

The technology simplifies the process of providing accurate, highly efficacious samples, and reproductions of applications. The sample experiences are provided via a scripting and configuration file linked to a plurality of video branches. The video branches are stitched together to mimic the look and feel of the original application.

The technology eliminates the need for developers to re-write a program to create a viewer and user experience identical to the native application.

The technology further comprises a user-launched application engine that: interacts with the host operating system to present one or more user interface (UI) elements; runs a presentation loop responsible for executing the tasks assigned to it by a state machine controller; and accepts user input from the user interface.

### BRIEF DESCRIPTION OF THE DRAWINGS

FIG. 1 shows an exemplary process as described herein.

FIG. 2 shows a second aspect of an exemplary process as described herein.

FIG. 3 shows an aspect of a process for creating a video-tree, as further described herein.

### DETAILED DESCRIPTION

### Terms

“Application store” and “App Store” refer to an online store for purchasing and downloading software applications and mobile apps for computers and mobile devices.

“Application” refers to software that allows a user to perform one or more specific tasks. Applications for desktop or laptop computers are sometimes called desktop applications, while those for mobile devices such as mobile phones and tablets are called apps or mobile apps. When a user opens an application, it runs inside the computer's operating system until the user closes it. Apps may be continually active, however, such as in the background while the device is switched on. The term application may be used herein generically, which is to say that—in context—it will be apparent that the term is being used to refer to both applications and apps.

“Streaming” refers to the process of delivering media content to a user, that is constantly received by and presented to an end-user while being delivered by a provider. A client end-user can use their media player to begin to play the data file (such as a digital file of a movie or song) before the entire file has been transmitted.

“Video Sampling” refers to the act of appropriating a portion of preexisting digital video and reusing it to recreate a new video.

“Feedback loop” refers to a process in which outputs of a system are routed back as inputs as part of a chain of cause-and-effect that forms a circuit or loop. The system can then be said to feed back into itself. In the context of application feature testing, the term feedback loop refers to the process of collecting end-user data as an input, analyzing that data, and making changes to the application to improve the overall user experience. The output is the set of improved user experience features.

“Native Application” refers to an application program that has been developed for use on a particular platform or device.

“Creative Concept Script” refers to the written embodiment of a creative concept. A creative concept is an overarching theme that captures audience interest, influences their emotional response and inspires them to take action. It is a unifying theme that can be used across all application messages, calls to action, communication channels and audiences.

“Computational Logic” refers to the use of logic to perform or reason about computation, or “logic programming.” A program written in a logic programming language is a set of sentences in logical form, expressing facts and rules within a specified domain.

“Application Content Branches” refer to the experiential content of a software application, organized into a branch-like taxonomy representative of the end-user experience.

“High Branching Factor” refers to the existence of a high volume of possible “Application Content Branches.” The branches contain a plurality of variances, each ordered within a defined hierarchical structure.

“Genetic Algorithm” refers to an artificial intelligence programming technique wherein computer programs are encoded as a set of genes that are then modified (evolved) using an evolutionary algorithm. It is an automated method for creating a working computer program from a high-level problem statement. Genetic programming starts from a high-level statement of “what needs to be done” and automatically creates a computer program to solve the problem. The result is a computer program able to perform well in a predefined task.

A “journey” or “user journey” refers to a script, such as for a video game that has a detailed theme. The journey tracks potential positions the user can be in, as defined by an environment, as well as particular avatars that the user may be associating with. The term can be used to describe which parts of the simulated environment give the most accurate simulation and can thereby produce a simulated script. It can also be used to describe a particular sequence of positions that a particular user has taken.

In marketing and business intelligence, “A/B testing” is a term used for randomized experimentation with a control performing against one or more variants.

“WYSIWYG (What You See Is What You Get) Editor” means a user interface that allows the user to view something very similar to the end result while a document is being created. In general, the term WYSIWYG implies the ability to directly manipulate the layout of a document without having to type or remember names of layout commands. In the context of video editing, “WYSIWYG” refers to an interface that provides video editing capabilities, wherein the video can be played back and viewed with the edits. The video editing with playback occurs within an editor mode.

Exemplary process

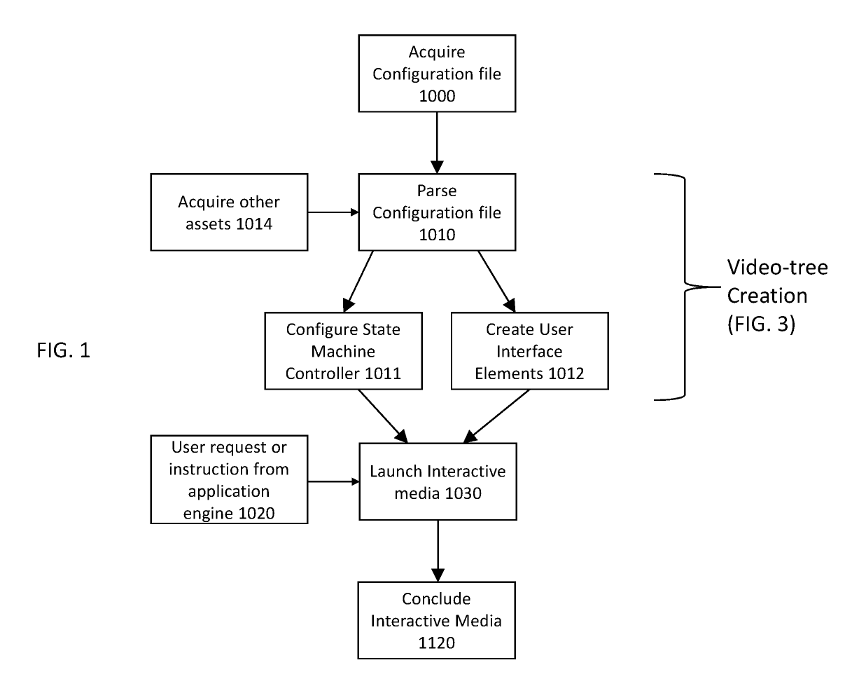

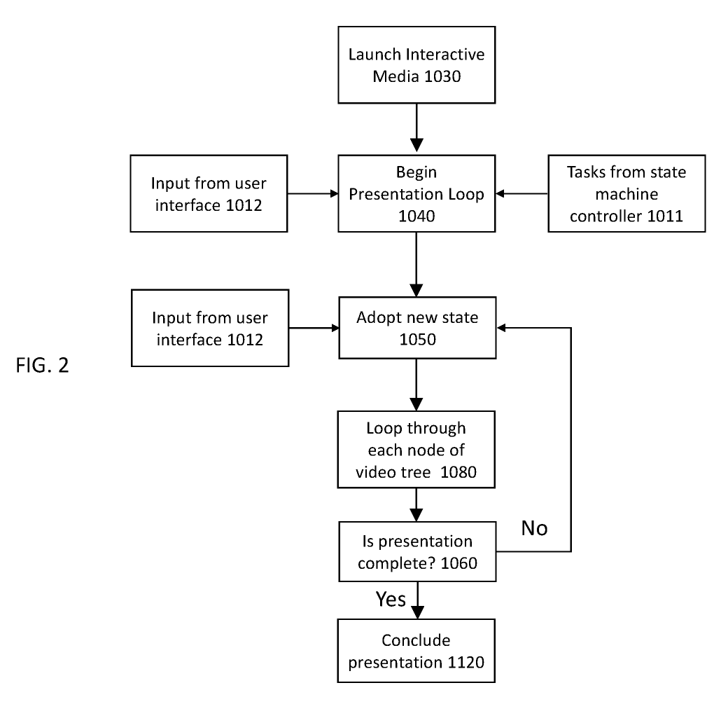

An exemplary process is shown in FIGS. 1 and 2, and is suitable for being executed on a computing apparatus having a memory, processor, input and output devices, as further described herein. FIG. 1 represents an overview of a process for reproducing a segment of interactive media as further described herein.

The system acquires a configuration file 1000 from a remote server or local source. The configuration file contains definitions of an item of interactive media that is to be reproduced.

The configuration file is parsed 1010 and used as instructions to acquire other video, audio, image or font files (collectively, “assets”) that represent the interactive media.

The configuration file is parsed 1011 and used to configure a state machine controller that involves a method of making a video-tree, as described further herein. The state machine drives the user experience, when reproducing the interactive media in question. The state machine is responsible for handling changes in the presentation of the interactive media, such as prompting audio or video files to begin playback, showing or hiding user interface elements, enabling and disabling touch responsiveness, playing, stopping or adjusting volume of sounds and music, directing the user to external materials (such as a website), updating text such as score indicators or other messaging on a display-screen, displaying, hiding or modifying (such as by moving, scaling, cropping, or rotating) images and videos, applying image and video effects from simple color shifts up to complex snapchat-style filters, collecting user-supplied responses to prompts such as survey data.

Parsing the configuration file 1012 is also used to create the various operating-system specific user interface elements (video players, image views, labels, touch detection areas, etc.) for display and interaction.

It is understood that the program is typically run within an operating system, or in the case of playable advertising, the interactive media can be run during use of a host application such as a web-browser, or an app on a mobile device.

At some point, the user takes an action that initiates playback of the segment of interactive media 1020. The program may also be driven by an application engine, such as by batch processing, or by utilizing a cloud computing paradigm.

The program launches the replicated segment of interactive media 1030 and interacts with the host operating system to present the user interface elements created in 1012, based on the state machine controller 1011.

When the presentation of the various aspects of the segment of interactive media is ended 1120, the program stops, and returns control to the host program.

In some embodiments, as shown in FIG. 2, the program may include a loop 1040 in which the segment of interactive media is presented multiple times in succession or in multiple different ways according to user input. In this way the program is responsible for executing various tasks assigned to it by the state machine controller 1011 dependent on accepting user input from the user interface 1012. In this situation, when the segment of interactive media is launched 1030, instead of being played once, there are multiple events under a user's direction that occur, including possibly the execution of the interactive media more than once. In this way, during playback of the segment of interactive media, the user can explore various user options, according to which the state machine controller responds to the user.

At any time, the state machine controller is able to transition to a new state 1050 based on its configuration. It may do so in response to user input, presentation events such as a video file completing playback, or internally configured events such as timed actions.

Each presentation has a defined end state, usually triggered by a user interaction, such as with a ‘close’ button 1060.

If the presentation is not ended 1070, the presentation loop will allow the state machine to submit its commands to an application engine. On transitioning between states, new video segments may be played, user interface elements may be shown or hidden, touch responsiveness may be activated or deactivated, etc.

The state runtime loop 1080 controls the playback of an individual node on the video tree. This is a self-contained unit that presents one meaningful part of the experience, e.g., in a video baseball game, “batter runs to first after hitting ball”.

During the state runtime loop, the user may interact with the presentation 1090. If the user performs a valid interaction, the user interface will capture the event and submit it to the state machine controller for processing. The state machine controller changes states based on what user is doing; for example it may interpret a user interaction and choose to transition to a new state, simulating the user's interaction with the original product.

In addition to user interaction events, the state machine controller can have its own configured events 1100. Typically these events are timed, such as displaying a “help” window if the user is inactive for a period of time.

If there is no user interaction and no state machine controller actions to take 1110, the presentation continues—videos and sounds play, etc.—until no more steps can be taken.

Video Sampling into Content Branches

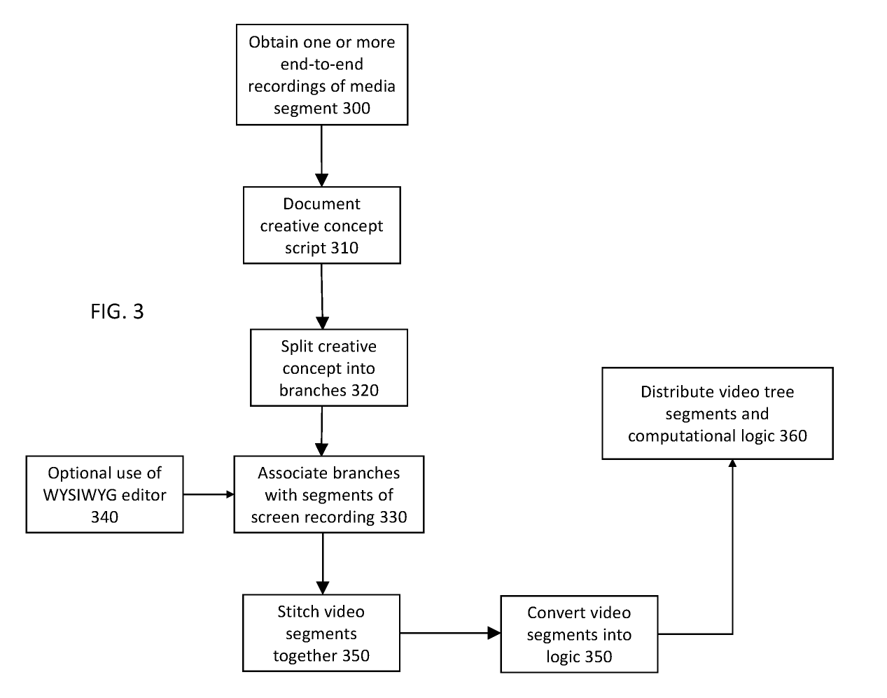

The digital video sampling process that lies behind the steps 1010, 1011, and 1012 of FIG. 1 includes a consumer device screen recording process such as acquiring the configuration file, creative concept scripting, screen recording footage splitting process, a video tree branching process, computational logic scripting, and distribution. An exemplary process for video-tree creation is as set forth in FIG. 3.

Screen Recording

As set forth in FIG. 3, the method includes recording 300 in whole or in part of a segment of an interactive media source such as an application program or playable advertisement, to produce one or more items of video footage. The end-to-end recording can be operated by a screen recording software, such as QuickTime Player, ActivePresenter, CamStudio, Snagit, Webinaria, Ashampoo Snap, and the like. In some cases, a single end-to-end recording of the desired application sample is all that is required for the remaining processing in order to replicate an application experience. In other cases, multiple recordings may be taken, especially if a tree with a high branching factor is being created. The recording can occur on any consumer computing device such as a desktop computer, mobile handset, or a tablet.

Creative Concept Scripting

Once the one or more screen recordings are completed, a creative concept is scripted 310 that outlines the application features contained in the screen recording. The creative concept script provides an outline of the user journey captured in the one or more screen recordings. Although not shown in FIG. 3, the design of the creative concept can optionally involve making further recordings 300, in which case steps 300 and 310 can be repeated as needed.

The creative concept outlines core concepts of the application. For instance, if the application is a game, the concept will outline the game's emphasis, player goals, flow, script and animation sequences. Storyboarding techniques such as those using a digital flow diagram are utilized to organize and identify the application's configuration and user journey.

For example, if a user is playing an application that provides an interactive baseball video-gaming experience on a handheld device, a screen recording is made of the user playing the game from the beginning of one inning to the end of that inning. A creative concept is then created of all of the user's interactions (concept segments), such as:

1. the user selects a baseball team (e.g., the New York Yankees);

2. the application informs the user that they are up to bat;

3. the user selects a bat;

4. the user selects a style of pitch;

5. the user swipes the device screen to engage the player to swing at a pitch.

Splitting the Screen Recording

Utilizing the user journey recorded in the creative concept script as a guide, the screen recordings are split into a variety of branches 320, referred to herein as a video tree. Each segment of the creative concept represents, and correlates with a piece of the screen recording and is a unique branch of the application video tree. The video is segmented into a plurality of branches to mirror all possible user interactions. Video editing software is used to split the screen recording into micro-segments.

For example, a game is segmented into a variety of micro-segments, some segments as short as 0.6 seconds, that are made to interconnect smoothly one after another. A segment can conceivably be as short as 0.03 seconds, so that the recording becomes a short sequence of effectively still images. Each micro-segment is allocated to a portion of the creative concept script. Although there is no specific limit to the length of a micro-segment, each micro-segment typically ranges in length from 0.01 s to 3 mins., such as 0.1 s to 1 min., or 0.5 s to 30 s, or 1 s to 15 s, where it is understood that any lower or upper endpoint of the foregoing ranges may be matched up with any other lower or upper end point.

Video-Tree Branching

Each creative concept branch is paired to the video representation (screen recording) 330 of the interactive media that corresponds to that branch. For example, a baseball game can contain hundreds of possible branches, each branch representing a portion of a game played by a user captured in the video recording. Each branch has the possibility of containing a plurality of sub-branches, each sub-branch organized as a possible portion of a user journey that has not yet been travelled, and associated video file.

In one embodiment, an additional program layer is created to automate the production of the video-tree branches. To implement this process, an editor, such as a WYSIWYG editor 340 is used to automate the creation of computational logic. The editor is instructed to download a file containing the storyboard, such as a document containing a flow chart, and programmatically creates the configuration logic for the video-tree. Here, the editor programmatically splits the input video into video-tree branches.

The WYSIWYG editor program is able to analyze the video segments, and distribute the segments into video-tree branches according to the creative concept provided. In this embodiment, the program integrates user-interaction detection, for example, the implementation of a user touch detection component, where each user touch on a screen generates a new branch within the video-tree. This allows the program to quickly generate the video-tree with a high degree of consistency and visual precision.

The various video-tree branches can be stitched together 350 so that they loop autonomously, thereby no longer requiring a developer to manually stitch video segments together using video editing software.

Computational Logic

In a preferred embodiment, a rules-based system is implemented to execute operation of the state machine controller. Such an approach simplifies the way that the operation is segmented. The rules-based system is used to create the video tree.

Computational logic can be scripted to mirror and perform actions represented in each video tree branch. Logic programming is a programming paradigm based on cognitive logic. A program written in a logic programming language is a set of sentences in logical form, expressing facts and rules about a specified domain. In the context of application reproduction, programmatic logic can be written to process rules of a video game, perform specified parameters of functions based on those rules, and respond to the existence of certain criteria.

There are two underlying processes that work together simultaneously: an internal engine containing programmed and predefined behaviors using computational logic (for example, playing a video segment, playing a sound, playing an interaction), and a downloadable configuration file that defines which behaviors to operate and when to operate them. Because the existing industry standard makes it impossible to download an application engine (containing source code and computational logic) into a consumer device, the technology described herein provides an alternative by pairing a generated application engine with the application configuration file. The generated engine is created using the video-tree branching method described herein, and paired with a downloadable configuration file of the original application.

Each branch of the application's video-tree correlates to an associated configuration logic 350. Likewise, the logic references specific branches of the application video-tree. The resulting logic-based program is able to play back the application and produce an application with the look and feel of the original application because the configuration file of the original application is paired to the generated video-tree engine.

In one preferred embodiment, logic is written as a configuration file containing sections that define different parts of the behavior of the program. The sections include resource controls (videos, sounds, fonts and other images), state controls (execution logic), and interface controls (collecting user input). Each individual element under each controller has an identifier that allows the controllers to coordinate interactions between each other and their elements, and a pre-determined set of action items it can execute. At runtime, the configuration file is parsed by the engine to enable or disable those interactions as a subset of its full functionality thereby creating the simulated experience.

The following is an example portion of code that defines a touch screen “tap” detector:

{

“name”: “toolbox slot 2 tap area”,
“kAOBViewSerializationKeyId”: 104,
“kAOBViewSerializationKeyType”:

“kAOBViewSerializationValueTypeGestureRecognitionView”,

“kAOBViewSerializationKeyRelativeX”: 0.408,
“kAOBViewSerializationKeyRelativeY”: 0.82308845,
“kAOBViewSerializationKeyRelativeWidth”: 0.186667,
“kAOBViewSerializationKeyRelativeHeight”: 0.128935,
“kAOBViewSerializationKeyInitiallyVisible”: true,
“kAOBViewSerializationKeyBackgroundColor”: {

“kAOBViewSerializationKeyRedColorComponent”: 0,
“kAOBViewSerializationKeyGreenColorComponent”: 0,
“kAOBViewSerializationKeyBlueColorComponent”: 0,
“kAOBViewSerializationKeyAlphaColorComponent”: 0

},
“kAOBViewSerializationKeyGestures”: [

{

“kAOBViewSerializationKeyGestureType”:

“kAOBViewSerializationValueGestureRecognitionTypeTap”,

“kAOBViewSerializationKeyTapCount”: 1,

“kAOBViewSerializationKeyStateTransitions”: [

{

“kAOBViewSerializationKeyStateFrom”: 22,

“kAOBViewSerializationKeyStateTransitionPossibilities”: [{

“kAOBViewSerializationKeyStateTo”: 23,
“kAOBViewSerializationKeyStateProbability”: 1

}]

}

]

}

]

},

This script instructs the user interaction engine to create a view with a defined set of features, such as size, color, and position. This view is a tap-detection view, and when the view is active and the user taps on it, the state machine controller will be instructed to transition to state ID #23 if it is in state ID #22. Upon exiting state ID #22 and entering state ID #23, the state machine controller may have further commands that it triggers in the engine to present or hide views, play sounds or movies, increase the user's score, and perform other functions as defined in its controller configuration.

In another embodiment of the logic programming process, the logic is machine generated. A programmatic approach, such as machine learning or a genetic algorithm, is utilized to recognize the existence of certain movements and user functions in the video-tree. The machine learning program identifies interactions occurring in the video-tree segments and matches those segments to the relevant portion of the configuration script. The paired logic is saved with the referenced video-tree segments.

For video-trees with interchangeable component videos, a genetic algorithm approach is typically implemented. Interchangeable “component videos” that make up branches of the video-tree are computationally arranged to create dynamic presentations of the information.

A machine learning approach is an appropriate technique where data-driven logic is created by inputting the results of user play-throughs into a machine learning program. The machine learning program dynamically optimizes the application experience to match what the statistics indicate has been most enjoyable or most successful. This allows the video-tree logic to be more adaptive and customized to individual users at time of execution. This in turn allows for dynamic, real-time application scripting, thereby providing a significant improvement over the current application experience, which is static and pre-scripted to a generic user type.

Distribution

The completed video and logic files are then made available for download 360 to first parties (the application developer), and third parties (such as advertising agencies, feature testing platforms).

The process of making the completed application experience available comprises: uploading the completed video-tree segments to a content distribution system, importing the computational logic to a database on a server, and providing access to these resources to the third parties.

Any client software integrated with the presentation system can acquire these resources and present the end-user with the application reproduction. The resources themselves remain under private control and as such do not have to go through any third party (such as App Store) review or approval. Importing the computational logic into a database provides the ability to dynamically create variant presentations using server-side logic to customize an experience to a particular user upon request or to otherwise optimize the presentation using previously mentioned machine learning or genetic techniques.

### Playable Advertising, User-Testing, and Analytics

The video-tree, once completed, is available for a variety of derivative uses. These include, but are not limited to: playable advertising; feature testing; live editing of application features based on user preferences; live data collection and storage of user interaction data correlated to the experience segment (unit); creation of a data array of touch events; playback with analytics and data visualizations; and automated A/B testing for performance evaluation.

Playable Advertising

When consumers are able to simultaneously view an advertisement of an application and interact with a sample of an application, it is well accepted that the likelihood that the consumer will ultimately download the application increases. Interactive advertising is enabled by the technology described herein by allowing for the rapid and accurate sampling of an application, and the accurate reproduction of the user experience.

The technology described herein enables developers and third parties to advertise the application by embedding the application experience into advertising channels. For instance, either third parties or application developers may release on the iOS App Store advertisements for applications that include the video-tree technology. For example, one application entitled “Mars Defence” (at the Internet website itunes.apple.com/us/app/mars-defence/id1143646844?Is=1&mt=8) is a tower-defense game that a developer has released to the public. In another example, a third party has released an advertisement in an app (available on the iOS App Store) that they do not own, (at the Internet website itunes.apple.com/us/app/tap-sports-baseball-2016/id1050831202?mt=8), but has created a demo experience with permission from the developers. The third party is able to provide the advertisement without any other corporate/engineering interaction with the application developer.

Feature Testing

To date, application developers have been unable to rapidly launch and test new application features due to restrictions on application stores such as Google Play and the iOS App Store. The ability to quickly test new themes, colors, gaming accessories, player options, and the like before releasing the features to the public is inhibited by reproduction limits, and other operational hurdles. The video-tree reproduction method described herein overcomes such feature testing hurdles. Entities may now sample and reproduce portions of an application and insert new features in a dynamic, real-time environment.

The feature testing presentation is solely video based. In this respect, pure video and video editing techniques are used to create parts of the application, and even, if desired, the entire application. Developing and integrating a feature into a game can take considerable effort in terms of 3D modeling, texturing, engine import, asset placement, scripting, state persistence, etc. The game or application will then have to be recompiled, possibly resubmitted to a distributor (such as an app store), and finally authorized by the end user for installation on their device. The video-tree technology described herein, allows for application presentations that are both lightweight to create (any video is ingested as content) and present (there are no requirements for a distributor intermediary, or end-user authorization). When the user is running an application that has integration with the video-tree technology described herein, the system platform is able to keep all application presentations in the most up-to-date condition, including downloading new or replacement resources as the original application changes.

Live Editing of Application Features Based on User Preferences

Understanding a user's application preferences requires real-time analysis of the user's interactions with the application. Doing so in a public test environment is largely impossible due to the difficulty of reproducing accurate application samples. Furthermore, integrating new features quickly is limited by the operational aspects of connecting with users via application stores. Live editing of application features based on user preferences is enabled by the technology described herein, by creating a sample environment in which the developer can view and implement changes to the game based on a variety of learned user preferences.

In one embodiment, the system can integrate market data from a third party which provides information about the user, such as their age, gender, location, and language. The system has a library of user characteristics paired with a variety of player preferences, such that, for example, an avatar in a game will change genders, age and language based on who the user of the application is.

Live Data Collection and Storage of User Interaction Data Correlated to the Application Segment (Unit)

Granular data of application user interactions can be used to optimize an application. Understanding, in aggregate and in detail, how users interface with an application can be helpful in making improvements to the application. Doing so within the environment of an application video-tree, allows for ease of access to the exact points at which a user performs a specific interaction. Granular analysis within the video-tree segments provides the developer with an organized, exploratory environment in which they can view how the user interacted, how they reacted to the interaction, and whether there were any negative responses to the interaction such as the user leaving the game, or stalling to move forward in the game. The underlying method allows developers, for the first time, the ability to replay the data against the user segments without having to record actual video of the user playing.

The user data and the computational logic interact with the video-tree segments to provide accurate replay. Because the system is built with a deterministic configuration for the presentation and recording of all user interaction and engine state change information, the system is able to precisely replay the user's experience including all video and audio by running the state machine controller with the recorded user interaction as input. The architecture allows for a “record once, replay many” construction that allows the developer to recreate many user experiences without requiring those users to individually transmit recorded video.

Creation of a Data Array of Touch Events

Many modern day applications involve the user physically interfacing with the application by applying a number of different types of touch motion to a flat-screen consumer device. These motions include swiping the screen with a finger, holding the finger down on a screen, tapping the screen, splaying two fingers to alter the zoom of a view, and combinations thereof. These finger-to-screen motions represent a wide range of possible actions occurring in the application environment, such as simulating the hitting of a ball in a baseball game, or the capturing of imaginary creatures. Unclear instructions on how to engage with the touch screen can often result in negative user reactions to an application. Likewise, many developers attempt to make the interaction as intuitive as possible. The ability to clearly analyze what touch mechanisms are successful versus those that are not requires the developer to collect and analyze that data.

The system described herein collects touch data as a data array. The array is created from touch events, including touch parameters that define the nature of the touch. These parameters can include data on, for example, how long the user touched the screen, the direction of a swipe on the screen, how many fingers were used, and the location on the screen of the touch. The touch data array is then mapped to the video-tree segments, and related application logic. The touch data array can be replayed as video to show how the user touched the screen and what motions the touch produced based on the deployed application logic.

Playback with Analytics and Data Visualizations

Playback of real-user interactions can be enhanced with data, such as the number of users engaged in a specific interaction with the application. Visualizations can also be generated to show the likelihood of certain interactions based on data of past user behavior, such as the likelihood of certain touch interactions. In one example, a heat map is utilized to show the likelihood of a user swiping a certain direction on a flat screen when reaching a specific point in the video-tree. The playback and analytics can be filtered for specified criteria so that playback can be produced to represent a specific user type, such as men of a specific age range living in a specific region.

Automated A/B Testing for Performance Evaluation

In the application testing industry, use of A/B testing means that an application developer will randomly allow some users to access the control version of the application, and other users will access variants of the application. Doing so today is complicated by the fact that deploying variants of an application is challenging due to application reproduction costs, as well as the application store approval process (described in greater detail above). With the technology described herein, it is possible to apply a novel approach to A/B testing. This novel approach involves the collection of a plurality of user data, and automating the playing of the artificial user data against variants of video-trees.

In one embodiment, the application developer provides a hypothesis of how players might respond to the proposed application variant. The system automatically produces data of how users actually interact with the application variants. New artificial user data is generated and compared with the control application user data. This allows the developer to analyze how new application features will play out without having to make the new features available to the public via an application store. It allows for the efficient, robust and thorough exploration of a wide variation of features, and the production of new user-interaction data, which ultimately results in an optimized application evaluation process.

### Computational Implementation

The computer functions for carrying out the methods herein can be developed by a programmer, or a team of programmers, skilled in the art. The functions can be implemented in a number and variety of programming languages, including, in some cases mixed implementations. Various programming languages may be used for portions of the implementation, such as C, C++, Java, Python, VisualBasic, Perl, .Net languages such as C#, and other equivalent languages not listed herein. The capability of the technology is not limited by or dependent on the underlying programming language used for implementation or control of access to the basic functions. Alternatively, the functionality could be implemented from higher level functions such as tool-kits that rely on previously developed functions for manipulating video streams.

The technology herein can be developed to run with any of the well-known computer operating systems in use today, as well as others, not listed herein. Those operating systems include, but are not limited to: Windows (including variants such as Windows XP, Windows95, Windows2000, Windows Vista, Windows 7, and Windows 8, Windows Mobile, and Windows 10, and intermediate updates thereof, available from Microsoft Corporation); Apple iOS (including variants such as iOS3, iOS4, and iOS5, iOS6, iOS7, iOS8, iOS9, and iOS10, as well as intervening and future updates to the same); Apple Mac operating systems such as OS9, OS 10.x (including variants known as “Leopard”, “Snow Leopard”, “Mountain Lion”, and “Lion”; the UNIX operating system (e.g., Berkeley Standard version); the Linux operating system (e.g., available from numerous distributors of free or “open source” software); and the Android OS for mobile phones.

To the extent that a given implementation relies on other software components, already implemented, those functions can be assumed to be accessible to a programmer of skill in the art.

Furthermore, it is to be understood that the executable instructions that cause a suitably-programmed computer to execute the methods described herein, can be stored and delivered in any suitable computer-readable format. This can include, but is not limited to, a portable readable drive, such as a large capacity “hard-drive”, or a “pen-drive”, such as connects to a computer's USB port, an internal drive to a computer, and a CD-Rom or an optical disk. It is further to be understood that while the executable instructions can be stored on a portable computer-readable medium and delivered in such tangible form to a purchaser or user, the executable instructions can also be downloaded from a remote location to the user's computer, such as via an Internet connection which itself may rely in part on a wireless technology such as WiFi. Such an aspect of the technology does not imply that the executable instructions take the form of a signal or other non-tangible embodiment. The executable instructions may also be executed as part of a “virtual machine” implementation.

The technology herein is not limited to a particular web browser version or type; it can be envisaged that the technology can be practiced with one or more of: Safari, Internet Explorer, Edge, FireFox, Chrome, or Opera, and any version thereof.

### Computing Apparatus

The methods herein can be carried out on a general-purpose computing apparatus that comprises at least one data processing unit (CPU), a memory, which will typically include both high speed random access memory as well as non-volatile memory (such as one or more magnetic disk drives), a user interface, one or more disks, and at least one network or other communication interface connection for communicating with other computers over a network, including the Internet, as well as other devices, such as via a high speed networking cable, or a wireless connection. There may optionally be a firewall between the computer and the Internet. At least the CPU, memory, user interface, disk and network interface, communicate with one another via at least one communication bus.

Computer memory stores procedures and data, typically including some or all of: an operating system for providing basic system services; one or more application programs, such as a parser routine, a file system, one or more databases if desired, and optionally a floating point coprocessor where necessary for carrying out high level mathematical operations. The methods of the technologies described herein may also draw upon functions contained in one or more dynamically linked libraries, stored either in memory, or on disk.

Computer memory is encoded with instructions for receiving input from one or more users and for replicating application programs for playback. Instructions further include programmed instructions for implementing one or more of video tree representations, state configuration machine and running a presentation. In some embodiments, the various aspects are not carried out on a single computer but are performed on a different computer and, e.g., transferred via a network interface from one computer to another.

Various implementations of the technology herein can be contemplated, particularly as performed on computing apparatuses of varying complexity, including, without limitation, workstations, PC's, laptops, notebooks, tablets, netbooks, and other mobile computing devices, including cell-phones, mobile phones, wearable devices, and personal digital assistants. The computing devices can have suitably configured processors, including, without limitation, graphics processors, vector processors, and math coprocessors, for running software that carries out the methods herein. In addition, certain computing functions are typically distributed across more than one computer so that, for example, one computer accepts input and instructions, and a second or additional computers receive the instructions via a network connection and carry out the processing at a remote location, and optionally communicate results or output back to the first computer.

Control of the computing apparatuses can be via a user interface, which may comprise a display, mouse, keyboard, and/or other items, such as a track-pad, track-ball, touch-screen, stylus, speech-recognition, gesture-recognition technology, or other input such as based on a user's eye-movement, or any subcombination or combination of inputs thereof. Additionally, implementations are configured that permit a replicator of an application program to access a computer remotely, over a network connection, and to view the replicated program via an interface.

In one embodiment, the computing apparatus can be configured to restrict user access, such as by scanning a QR-code, requiring gesture recognition, biometric data input, or password input.

The manner of operation of the technology, when reduced to an embodiment as one or more software modules, functions, or subroutines, can be in a batch-mode—as on a stored database of application source code, processed in batches, or by interaction with a user who inputs specific instructions for a single application program.

The results of application simulation, as created by the technology herein, can be displayed in tangible form, such as on one or more computer displays, such as a monitor, laptop display, or the screen of a tablet, notebook, netbook, or cellular phone. The results can further be printed to paper form, stored as electronic files in a format for saving on a computer-readable medium or for transferring or sharing between computers, or projected onto a screen of an auditorium such as during a presentation.

All references cited herein are incorporated by reference in their entireties.

The foregoing description is intended to illustrate various aspects of the instant technology. It is not intended that the examples presented herein limit the scope of the appended claims. The invention now being fully described, it will be apparent to one of ordinary skill in the art that many changes and modifications can be made thereto without departing from the spirit or scope of the appended claims.

1. A method for reproducing a segment of interactive media, the method comprising:
creating a presentation of the segment of interactive media by:
deriving a creative concept script for the presentation;
capturing one or more items of video footage related to the segment of interactive media;
collecting one or more assets related to the segment of interactive media; ;
splitting the creative concept script into a number of branches;
sampling each of the one or more items of video footage and splitting it into content branches;
pairing each of the creative concept script branches with the items of video footage;
creating a configuration file that defines a logical form for the presentation; and
making the configuration, video footage, and assets available to users;
distributing the presentation to one or more client devices by acquiring a configuration file from a remote server or local source;
parsing the acquired configuration file; and
using the parsed configuration file to instruct on acquiring one or more video files and assets;
and
executing the presentation by
configuring a state machine controller for one or more features of application user experience;
creating one or more user interface elements for display and interaction, and
processing configuration directives and user interaction to reproduce a series of segments thereby reproducing the segment of interactive media.

2. The method of claim 1, wherein the one or more assets are files selected from: audio, image, and font files.

3. The method of claim 1, wherein the user interface elements are operating system specific.

4. The method of claim 1, wherein the interactive media is selected from: playable advertising, and a video game.

5. The method of claim 1, wherein the user interface elements are selected from: video players, image views, labels, and touch detection areas.

6. The method of claim 1, wherein the one or more features of application user experience are selected from: prompting audio or video files to begin playback, showing or hiding user interface elements, enabling and disabling touch responsiveness, playing, stopping or adjusting volume of sounds and music, directing the user to external materials, updating text on a display-screen, displaying, hiding or modifying images and videos, applying image and video effects, and collecting user-supplied responses to prompts such as survey data.

7. The method of claim 1, executed by an application engine that is configured to:
execute the tasks assigned to it by the state machine controller; and
accept user input from a user interface.

8. The method of claim 7, wherein the state machine controller monitors user activity and prompts the user in case of a period of inactivity.

9. The method of claim 7 wherein, when the reproduction segment is complete, the engine closes all user interfaces.

10. The method of claim 1, wherein the state machine controller further executes:
one or more dynamic transitions based on user input;
one or more presentation events; and
one or more internally configured events.

11. The method of claim 10, wherein the presentation contains a defined end state triggered by a user interaction with a ‘close’ button.

12. The method of claim 11, wherein the presentation, when not completed, allows the state machine to submit commands to the engine, selected from: prompting audio or video files to begin playback, replay of a video, hiding or showing user interface elements, and activating or deactivating touch responsiveness.

13. The method of claim 1, wherein the state machine controller comprises a state runtime loop control that controls the playback of each individual node of a video-tree.

14. The method of claim 13, wherein the video-tree comprises:
a self-contained “branch” unit that presents a segment of the application experience;
a user-interaction experience;
a user-interface that captures a user-interaction event, and submits the event to the state machine controller for processing; and
an option for the state machine controller to transition to a new state, simulating the user's interaction with the original application.

15. A computer system configured to execute the method of claim 1.

16. A computer-readable medium encoded with instructions to execute the method of claim 1.
